(19) United States
(12) Patent Application Publication
(10) Pub. No.: US 2016/0373617 A1
(43) Pub. Date: Dec. 22, 2016

(54) SYSTEM AND METHOD FOR SYNCHRONIZING VIDEO SIGNAL AND WIRELESS SENSOR SIGNAL

(71) Applicant: RD-TEK CO., LTD., Daejeon (KR)

(72) Inventor: Song Hwan CHOI, Daejeon (KR)

(21) Appl. No.: 15/121,539

(22) PCT Filed: Feb. 12, 2015
(86) PCT No.: PCT/KR2015/001401

§ 371 Date: Aug. 25, 2016

(30) Foreign Application Priority Data
Feb. 25, 2014 (KR) 10-2014-0021823

(51) Int. Cl. H04N 5/073; H04N 5/067; H04N 5/247

(52) U.S. Cl. CPC H04N 5/073; H04N 5/247; H04N 5/0675

(57) ABSTRACT

A system for synchronizing video and wireless sensor signals includes: camera device with first synchronization clock, which generates video signal by photographing an object, and transmits, to computing device, the video signal into which first time tag is inserted; wireless sensor with second synchronization clock and wireless communication module, which generates sensor signal by sensing a changing state value from the object, and transmits, to sensor signal collecting unit via the wireless communication module, the video signal into which second time tag is inserted; zero-point setting device transmitting a zero-point setting signal containing reference time information to the camera device and the wireless sensor; sensor signal collecting unit collecting a sensor signal wirelessly transmitted from the wireless sensor and transmitting the sensor signal to the computing device; and computing device receiving the video and sensor signals and performing synchronization between the video and sensor signals.

### TECHNICAL FIELD

The present invention relates to a synchronization system and method between a plurality of signals and, more particularly, to a system and method for synchronizing a wirelessly transmitted sensor signal and a video signal.

### BACKGROUND ART

With the recent development of video and communication technology, attempts are made to synchronize a video signal, obtained by photographing a moving subject for photography, and a sensor signal.

Specifically, if a plurality of signals is not synchronized, it is unaware whether an event included in a specific video signal and an event included in a sensor signal are the same event, that is, whether the events have been obtained at the same time. Accordingly, in order to derive useful information by synthesizing various signals varying over time, the times of signals transmitted by a plurality of signal collection devices connected to a network need to be accurately synchronized within a specific range.

For example, in order to analyze sports, it is necessary to obtain a video signal by photographing an athlete, that is, a subject for photography, through a camera with respect to events that require separate equipment, such as golf, a pole vault, and a game of Western archery, in addition to events that do not require separate equipment, such as a marathon and field and track events, to simultaneously generate a sensor signal by sensing various state values (e.g., speed, pressure, blood pressure, a heart rate, an electromyogram of speed, temperature, the direction of the wind, and pressure varying in the surroundings of the subject for photography) that vary in the subject for photography or an object which is attached to the subject for photography or moves along with the subject for photography through the sensor, and to synchronize the sensor signal and the photographed video signal.

In this case, there is an advantage in that more accurate analysis can be performed if signals are obtained from larger cameras and sensors.

However, conventionally, for the purpose of sports analysis, a sensor signal had to be provided to the outside through a wired cable in the state in which a sensor had been directly attached to a subject for photography. Accordingly, a smooth movement of the subject for photography is hindered, serving as a great obstacle to accurate analysis.

In order to solve the aforementioned problem, there has been proposed a technology in which a sensor signal is wirelessly transmitted. However, such a conventional technology is problematic in that a computation load of data for synchronization is excessive because an error attributable to a transmission delay time generated when a sensor signal is wirelessly transmitted had to be calculated and a process for correcting time information based On the calculated error has to be accompanied. Furthermore, the conventional technology cannot be applied to a practical measuring environment, such as sport posture analysis, due to a unique limit, such as that reference time information has to be repeatedly transmitted to a wireless sensor using a wired network, such as a cable, in order to calculate the error.

### DISCLOSURE

### Technical Problem

The present invention has been made to solve the conventional problems, and an object of an embodiment of the present invention is to provide a system and method, which can perform synchronization with a video signal by wirelessly transmitting and receiving a sensor signal and also perform precise synchronization with the video signal even without a data processing process for calculating a transmission delay time generated when the sensor signal is wirelessly transmitted.

### Technical Solution

In accordance with an aspect of the present invention, there is provided a system for synchronizing a video signal and a wireless sensor signal, including a camera device which includes a synchronization watch, generates a video signal by photographing a subject for photography, and transmits the video signal into which a first time tag has been inserted for each first unit time by the first synchronization watch to a computing device, a wireless sensor which includes a second synchronization watch and a wireless communication module, generates a sensor signal by sensing a subject for photography or a state value varying outside the subject for photography, and transmits the sensor signal into which a second time tag has been inserted for each second unit time by the second synchronization watch to a sensor signal collection unit through the wireless communication modulo, a zero-point setting device which transmits a zero-point setting signal including reference time information to the camera device and the wireless sensor over a wired network, the sensor signal collection unit which collects the sensor signal wirelessly transmitted by the wireless sensor and transmits the sensor signal to the computing device, and the computing device which receives the video signal and the sensor signal and performs synchronization between the video signal and the sensor signal. The local times of the first synchronization watch and the second synchronization watch are changed into the reference time in response to the zero-point setting signal, and the computing device performs the synchronization between the video signal and the sensor signal based on time information included in the first time tag and the second time tag.

Furthermore, the sensor signal collection unit may collect all sensor signals wirelessly transmitted by a plurality of the wireless sensors and transmit the collected sensor signals to the computing device.

Furthermore, the computing device may compare the time information of the first time tag with the time information of the second time tag, and may perform synchronization between the video signal and the sensor signal each having time information within a predetermined range based on a result of the comparison.

Furthermore, the computing device may transmit a control signal to control a first unit time to the camera device or transmit a control signal to control the second unit time to the wireless censor based on speed of the subject for photography.

Furthermore, the computing device may assign unique identification information to an event on which synchronization between the video signal and the sensor signal has been normally completed, and may store the event in a data storage medium.

In accordance with another aspect of the present invention, there is provided a method for synchronizing a video signal and a sensor signal using a camera device in which a first synchronization watch has been embedded, a wireless sensor in which a second synchronization watch and a wireless communication module have been embedded, a zero-point setting device, a sensor signal collection unit, and a computing device, including the steps of transmitting, by the zero-point setting device, a zero-point setting signal including reference time information, to the camera device and the wireless sensor over a wired network, changing, by the first synchronization watch, its own local time into a reference time based on the zero-point setting signal and changing, by the second synchronization watch, its own local time into the reference time based on the zero-point setting signal, generating, by the camera device, a video signal by photographing a subject for photography, inserting a first time tag into the video signal for each first unit time using the first synchronization watch, and transmitting the video signal to the computing device, generating, by the wireless sensor, a sensor signal by sensing a subject for photography or a state value varying outside the subject for photography, inserting a second time tag into the sensor signal for each second unit time using the second synchronization watch, and transmitting the sensor signal to the sensor signal collection unit through the wireless communication module, collecting, by the sensor signal collection unit, the wirelessly transmitted sensor signal and transmitting the sensor signal to the computing device, and receiving, by the computing device, the video signal and the sensor signal and performing synchronization between the video signal and the sensor signal. The computing device performs the synchronization between the video signal and the sensor signal based on time information included in the first time tag and the second time tag.

Furthermore, the sensor signal collection unit may collect all sensor signals wirelessly transmitted by a plurality of the wireless sensors and transmit the collected sensor signals to the computing device.

Furthermore, the computing device may compare the time information of the first time tag with the time information of the second time tag, and may perform synchronization between the video signal and the sensor signal each having time information within a predetermined range based on a result of the comparison.

Furthermore, the computing device may transmit a control signal to control a first unit time to the camera device or transmit a control signal to control the second unit time to the wireless sensor based On speed of the subject for photography.

Furthermore, the computing device may assign unique identification information to an event on which synchronization between the video signal and the sensor signal has been normally completed, and may store the event in a data storage medium.

### Advantageous Effects

In accordance with an embodiment of the present invention, a plurality of video signals and wireless sensor signals can be synchronized rapidly and accurately.

Furthermore, the plurality of wireless sensors changes their own local times into a reference time before they send signals to the computing apparatus. Accordingly precise time synchronization between the plurality of wireless sensors distributed into several locations can be implemented because a temporal error attributable to the transmission and reception of a signal can be removed.

Furthermore, the synchronization watch embedded in each of the plurality of wireless sensors generates time information and inserts the time information into a sensor signal for each unit time until an event is terminated based on a single reference time previously received before the event is generated. Accordingly, a condition in which a reference time has to be transmitted to a wireless sensor over a wired network at a specific interval can be removed compared to a conventional method. Accordingly, an applicable condition and environment are significantly improved and the system and method can be easily used by anyone.

Furthermore, by reducing the calculation of a temporal error and the number of reference times transmitted, power consumption in a communication module embedded in the camera device and the wireless sensor can be reduced and the lifespan of a part or device for synchronization can be extended.

### DESCRIPTION OF DRAWINGS

FIG. 1 is a configuration diagram schematically showing the configuration of a system for synchronizing a video signal and a wireless sensor signal according to an embodiment of the present invention.

FIG. 2 is a diagram showing an example in which the synchronization of a video signal and a wireless sensor signal is implemented in sports analysis according to an embodiment of the present invention.

FIG. 3 is a diagram showing all example in which the local times of camera devices and wireless sensors are changed into a reference time in response to a zero-point setting signal according to an embodiment of the present invention.

FIG. 4 is a diagram sequentially showing the steps of a method for synchronizing a video signal and a wireless sensor signal according to an embodiment of the present invention.

### MODE FOR INVENTION

Embodiments disclosed in this specification should not be interpreted as limiting or used to limit the scope of the present invention. It is evident to those skilled in the art that a descriptor including the embodiments of this specification has various applications. Accordingly, unless otherwise defined by the claims, some embodiments described are illustrative for better understanding, and the scope of the present invention is not intended to be restricted by the embodiments. Furthermore, in describing the present invention, a detailed description of the known functions and constructions will be omitted if it is deemed to make the gist of the present invention unnecessarily vague.

Writing, such as that any element “transmits”, “receives”, “transfers” or “applies” something to another element, may directly act on another element, but should be understood to be implemented through yet another element included therebetween.

Embodiments of the present invention are described in more detail below with reference to the accompanying drawings.

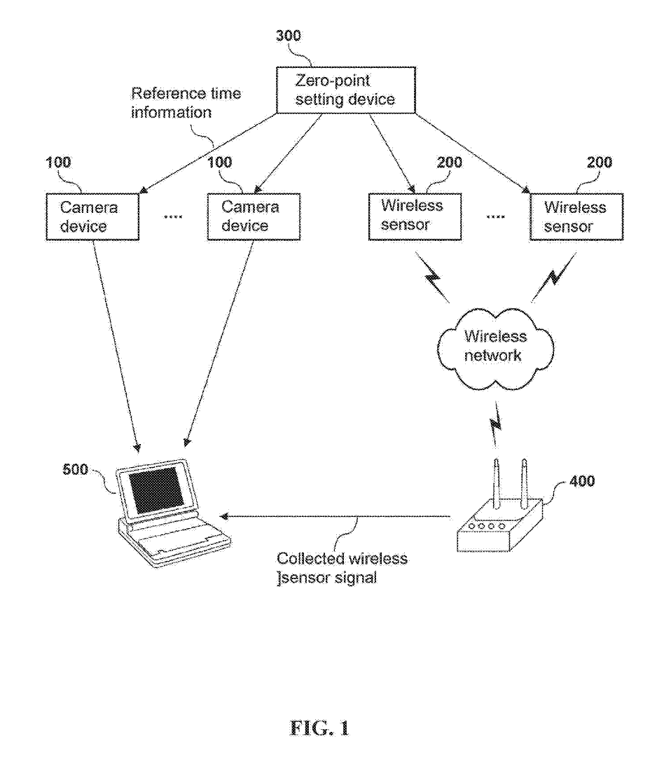

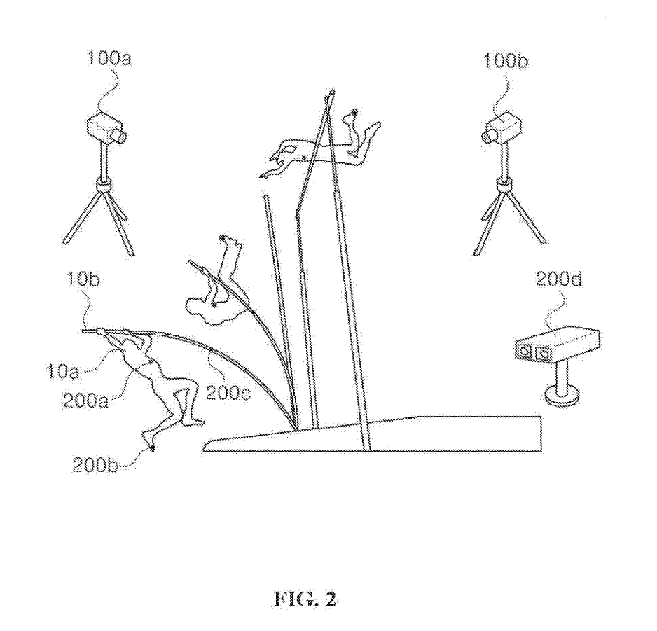

FIG. 1 is a configuration diagram schematically showing the configuration of a system for synchronizing a video signal and a wireless sensor signal according to an embodiment of the present invention. FIG. 2 is a diagram showing an example in which the synchronization of a video signal and a wireless sensor signal is implemented in sports analysis according to an embodiment of the present invention.

Referring to FIG. 1, the system for synchronizing a video signal and a wireless sensor signal according to an embodiment of the present invention includes camera devices 100, wireless sensors 200, a zero-point setting device 300, a sensor signal collection unit 400, and a computing device 500.

The camera device 100 generates a video signal by photographing a subject for photography 10 and then sends the video signal to the computing device 500. In this case, the subject for photography 10 refers to all of objects capable of being photographed, such as an athlete, a vehicle, an animal, a typhoon, and yellow sand.

Furthermore, a first synchronization watch is embedded in the camera device 100. Specifically, the first synchronization watch inserts a first time tag including its own local time into a video signal for each first unit time. That is, a first time tag, that is, time information generated by a corresponding video signal, may be inserted into each video signal. The first time tag may be said to be a kind of nameplate to identifier of each video signal. The computing device 500 may match a wireless sensor signal capable of synchronization with a video signal with the video signal based on the time information of a first time tag. A plurality of the camera devices 100 may be used with respect to a single event.

The wireless sensor 200 generates a sensor signal by sensing the subject for photography 10 or a state value varying outside a subject for photography 10 and then sends the sensor signal to the sensor signal collection unit 400. A second synchronization watch and a wireless communication module are embedded in the camera device 100. Specifically, the second synchronization watch inserts a second time tag including its own local time into a senior signal for each second unit time. That is, a second time tag, that is, time information generated by a corresponding sensor signal, may be inserted into each sensor signal. The second time tag may be said to be a kind of nameplate to identifier of each sensor signal. The computing device 500 may match a video signal capable of synchronization with a sensor signal with the sensor signal based on the time information of a second time tag. A plurality of the wireless sensors 200 may be attached to or installed on the subject for photography 10 or the outside of the subject for photography 10 with respect to a single event.

In this case, the state value sensed by the wireless sensor 200 should be understood as a term of a broad sense including all of measurable physical quantities, including speed, direction, distance, weight, location, pressure, temperature, frequency, conductivity, inclination, voltage, current, brain waves, electrocardiogram, and heart rate of the subject for photography 10 or outside the subject for photography 10. Furthermore, the wireless communication module may be driven in accordance with a wireless communication method, such as Zigbee, Bluetooth, or RFID.

An example in which an embodiment of the present invention is used for the analysis of a pole vault is described with reference to FIG. 2. A heart rate detection sensor 200a and a weight detection sensor 200b may be attached to a pole vault athlete 10a, that is, a subject for photography 10. A wireless sensor 200c capable of sensing an inclination or a degree of bending may be attached to a pole 10b, that is, another subject for photography 10. A wireless sensor 200d (e.g., a speed gun) capable of sensing moving speed or moving direction of the subject for photography 10 may be located in a specific distance from the subject for photography 10. Furthermore, at least one camera device 100 may be disposed in an area of a specific range or less from the moving route of the subject for photography 10 so that it can photograph the subject for photography 10.

For another example, when a game of Western archery is analyzed, an inclination or tension of an arrow may be sensed and simultaneously the direction of the wind or the velocity of the wind of the surroundings may be sensed.

The zero-point setting device 300 transmits a zero-point setting signal to the camera device 100 and the tireless sensor 200. The zero-point selling signal includes reference time information. The synchronization watch embedded in each of the camera device 100 and the wireless sensor 200 aligns each local time to the single reference time.

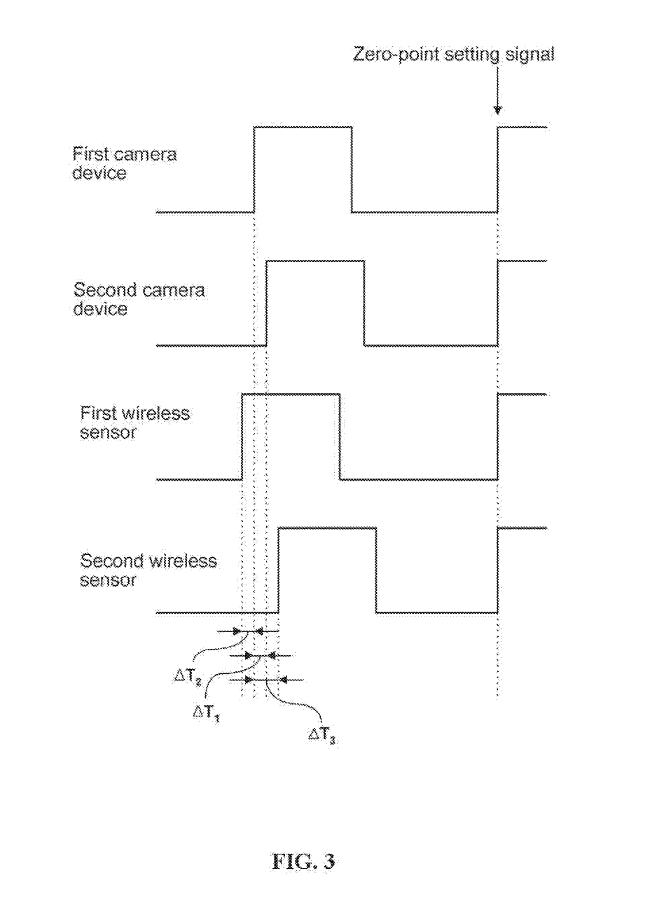

FIG. 3 is a diagram showing an example in which the local times of the camera devices 100 and the wireless sensors 200 are changed into a reference time in response to a zero-point setting signal according to an embodiment of the present invention.

From FIG. 3, the local time, first unit time, and second unit time of each of a first camera device, a second camera device, a first wireless sensor, and a second wireless sensor may be checked. In FIG. 3, all of the unit times (i.e., pulse widths in FIG. 3) have been illustrated as being the same, for convenience sake, but are not limited thereto, and those skilled in the art may easily underhand that the unit times may be differently set. It may be seen that an error has been generated in the local times of the first camera device, the second camera device, the first wireless sensor, and the second wireless sensor before the zero-point setting device 300 applies a zero-point setting signal.

Specifically, it may be seen that the local time of the second camera device is late by ΔT1, the local time of the first wireless sensor is early by ΔT2, and the local time of the second wireless sensor [symbol] the local time is late by ΔT3 on the basis of the local time of the first camera device. Accurate synchronization between a video signal and a wifeless sensor signal is not secured due to such errors ΔT1, ΔT3, and ΔT3. Accordingly, the zero-point setting device 300 connects to the first camera device, the second camera device, the first wireless sensor, and the second wireless sensor at the same time or sequentially in a wired manner and transfers a zero-point setting signal to time. When the zero-point setting signal is normally transferred and synchronization according to reference time information is completed, the wireless sensors are separated from the zero-point setting device.

Accordingly, the local times of a first camera device, a second camera device, a first wireless sensor, and a second wireless sensor, such as those shown on the right side of FIG. 3, are identically changed into a single reference time. Accordingly, pulses for inserting time tags can be generated at the same time, and a problem attributable to an error or delay even in a wireless network environment can be obviated.

The sensor signal collection unit 400 collects sensor signals wirelessly transmitted by the wireless sensors 200. That is, the sensor signal, collection unit 400 may receive all of sensor signals transmitted by the plurality of wireless sensors 200 in addition to a single wireless sensor 200, and sends the collected sensor signals to the computing device 500. In this case, the sensor signals of the respective wireless sensors 200 need to be distinguished from each other. ID information about a wireless sensor 200 that has generated a corresponding sensor signal may be included in each sensor signal. Alternatively, the sensor signal collection unit 400 may distinguish the wireless sensors 200 from each other based on ID information and selectively receive sensor signals.

Furthermore, if sensor signals having a computational load or more which can be processed by the sensor signal collection unit 400 are transmitted by the wireless sensors 200, the sensor signal collection unit 400 may store the received sensor signals in a temporary data storage medium separately provided inside or outside the sensor signal collection unit 400 in order to prevent a data loss.

The computing device 500 performs synchronization between a video signal and a sensor signal based on time information included in a first time tag and a second time tag. Specifically, the computing device 500 extracts time information from a first time tag and a second time tag, sequentially aligns the extracted time information, performs a comparison on the time information of the first time tag and the second time tag, and matches a video signal and a sensor signal including time information within a predetermined range.

For example, it may be assumed that a (1-1)-th time tag has time information of 0.013 second, a (1-2)-th time tag has time information of 0.016 second, a (2-1)-th time tag has time information of 0.013 second, and a (2-2)-th time tag has time information of 0.016 second. In this case, the computing device 500 may synchronize a video signal into which the (1-1)-th time tag has been inserted with a sensor signal into which the (2-1)th time tag has been inserted, and may synchronize a video signal into which the (1-2)-th time tag has been inserted with a sensor signal into which the (2-2)-th time tag has been inserted.

For another example, if a (1-1)-th time tag has time information of 1.740 second, a (1-2)-th time tag has time information of 1.752 second, a (2-1)-th time tag has time information of 1.738 second, a (2-2)-th time tag has time information of 1.753 second, and an error is within 0.003 second, the time information may be set so that synchronization is normally performed. In this case, the computing device 500 may synchronize a video signal into which the (1-1)-th time tag has been inserted with a sensor signal into which the (2-1)-th time tag having an error of 0.002 second has been inserted, and may synchronize a video signal into which the (1-2)-th time tag has been inserted with a sensor signal into which the (2-2)-th time tag having an error of 0.001 second has been inserted.

Such a computing device 500 may be a PC representatively, but is not limited thereto, and may be any device capable of data processing according to a specific program and/or algorithm while performing communication with an external device over wired/wireless networks.

Meanwhile, in accordance with another embodiment of the present invention, the computing device 500 may transmit a control signal that controls a first unit time to the camera device 100 or transmit a control signal that controls a second unit time to the wireless sensor 200 based on speed of the subject for photography 10.

Specifically, if moving speed of the subject for photography 10 is sensed as being less than a reference value, a time tag may be slowly inserted into a video signal and a sensor signal compared to a case where moving speed of the subject for photography 10 in sensed as being the reference value or more so as to reduce a load of the camera device 100 or the wireless sensor 200. In this case, the control signal that controls the first unit time or the second unit time may be set in various manners by classifying moving speed of the subject for photography 10 as a plurality of sections.

Furthermore, the computing device 500 may assign unique identification information to an event that belongs to one or more events and on which synchronization between a video signal and a sensor signal has been normally completed, and may store the corresponding event in the data storage medium. In this case, the event may refer to a point of time at which a zero-point setting signal is applied to the camera device 100 and the wireless sensor 200 to a point of time at which the collection of video signals and sensor signals for the subject for photography 10 and surrounding environments is terminated. Furthermore, the unique identification information is information for distinguishing events from each other, and may include a date, a place, and information about the subject for photography 10, for example. The unique identification information may be written as a combination of one or more numbers, characters, and symbols.

FIG. 1 is a diagram sequentially showing the steps of a method for synchronizing a video signal and a wireless sensor signal according to an embodiment of the present invention.

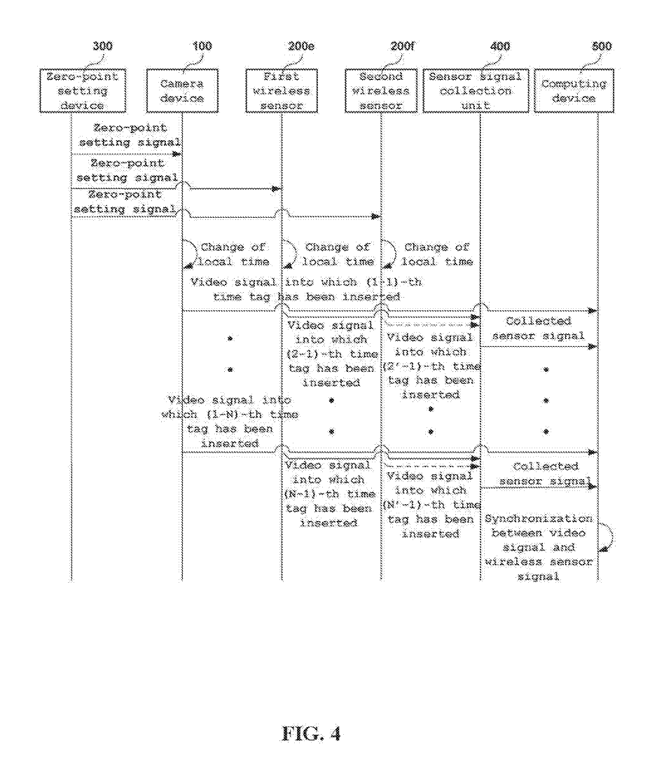

Referring to FIG. 4, in the method for synchronizing a video signal and a wireless sensor signal according to an embodiment of the present invention, first, a step for transmitting, by the zero-point setting device 300, a zero-point setting signal including reference time information to the camera device 100 and the wireless sensor 200 is performed. In this case, a plurality of the camera devices 100 and a plurality of the wireless sensors 200 may be included. The zero-point setting signal may be transmitted to the camera device 100 and the wireless sensor 200 at the same time or sequentially.

Next, the first synchronization watch changes its own local time into the reference time based on the zero-point setting signal, and the second synchronization watch changes its own local time into the reference time based on the zero-point setting signal.

Next, a step for generating, by the camera device 100, a video signal by photographing the subject for photography 10, inserting a first time tag into the video signal for each first unit time using the first synchronization watch, and transmitting the video signal to the computing device 500 and a step for generating, by the wireless sensor 200, a sensor signal by sensing the subject for photography 10 or state values varying outside the subject for photography 10, inserting a second time tag into the sensor signal for each second unit time using the second synchronization watch, and transmitting the sensor signal to the sensor signal collection unit 400 through the wireless communication module may be performed.

Next, a step for collecting, by the sensor signal collection unit 400, the wirelessly transmitted sensor signals and transmitting the sensor signals to the computing device 500 and a step for receiving, by the computing device 500, the video signal and the sensor signal and performing synchronization between the video signal and the sensor signal may be performed.

Specifically, the computing device 500 may extract time information from the first time tag inserted into the video signal, and may extract time information from the second time tag inserted into the sensor signal. The computing device 500 performs a comparison on the pieces of extracted time information. If it is determined that the pieces of extracted information are the same or have an error of a reference range, the computing device 500 may perform synchronization on a video signal and a sensor signal into each of which a time tag corresponding to corresponding time information has been inserted.

The term, such as “include” described above, means that a corresponding element may be included unless explicitly described to the contrary, and should be understood to imply the inclusion of other elements but not the exclusion of any other elements.

The aforementioned embodiments of the present invention have been disclosed for illustrative purposes, and the present invention is not restricted by the embodiments. Furthermore, those skilled in the art to which the present invention pertains may modify and change the present invention in various ways within the spirit and scope of the present invention, and such modifications and changes should be construed as belonging to the scope of the present invention.

### DESCRIPTION OF REFERENCE NUMERALS

10: subject for photography
100: camera device
200: wireless sensor
300: zero-point setting device
400: sensor signal collection unit
500: computing device

1. A system for synchronizing a video signal and a wireless sensor signal, comprising:
a camera device which comprises a first synchronization watch, generates a video signal by photographing a subject for photography, and transmits the video signal into which a first time tag has been inserted for each first unit time by the first synchronization watch to a computing device;
a wireless sensor which comprises a second synchronization watch and a wireless communication module, generates a sensor signal by sensing a subject for photography or a state value varying outside the subject for photography, and transmits the sensor signal into which a second time tag has been inserted for each second unit time by the second synchronization watch to a sensor signal collection unit through the wireless communication module;
a zero-point setting device which transmits a zero-point setting signal comprising reference time information to the camera device and the wireless sensor over a wired network;
the sensor signal collection unit which collects the sensor signal wirelessly transmitted by the wireless sensor and transmits the sensor signal to the computing device; and
the computing device which receives the video signal and the sensor signal and performs synchronization between the video signal and the sensor signal,
wherein local times of the first synchronization watch and the second synchronization watch are changed into the reference time in response to the zero-point setting signal, and
the computing device performs the synchronization between the video signal and the sensor signal based on time information included in the first time tag and the second time tag.

2. The system of claim 1, wherein the sensor signal collection unit collects all sensor signals wirelessly transmitted by a plurality of the wireless sensors and transmits the collected sensor signals to the computing device.

3. The system of claim 1, wherein the computing device compares the time information of the first time tag with the time information of the second time tag and performs synchronization between the video signal and the sensor signal each having time information within a predetermined range based on a result of the comparison.

4. The system of claim 1, wherein the computing device transmits a control signal to control a first unit time to the camera device or transmits a control signal to control the second unit time to the wireless sensor based on speed of the subject for photography.

5. The system of claim 1, wherein the computing device assigns unique identification information to an event on which synchronization between the video signal and the sensor signal has been normally completed and stores the event in a data storage medium.

6. A method for synchronizing a video signal and a sensor signal using a camera device in which a first synchronization watch has been embedded, a wireless sensor in which a second synchronization watch and a wireless communication module have been embedded, a zero-point setting device, a sensor signal collection unit, and a computing device, the method comprising:
transmitting, by the zero-point setting device, a zero-point setting signal comprising reference time information, to the camera device and the wireless sensor over a wired network;
changing, by the first synchronization watch, its own local time into a reference time based on the zero-point setting signal and changing, by the second synchronization watch, its own local time into the reference time based on the zero-point setting signal;
generating, by the camera device, a video signal by photographing a subject for photography, inserting a first time tag into the video signal for each first unit time using the first synchronization watch, and transmitting the video signal to the computing device;
generating, by the wireless sensor, a sensor signal by sensing a subject for photography or a state value varying outside the subject for photography, inserting a second time tag into the sensor signal for each second unit time using the second synchronization watch, and transmitting the sensor signal to the sensor signal collection unit through the wireless communication module;
collecting, by the sensor signal collection unit, the wirelessly transmitted sensor signal and transmitting the sensor signal to the computing device; and
receiving, by the computing device, the video signal and the sensor signal and performing synchronization between the video signal and the sensor signal,
wherein the computing device performs the synchronization between the video signal and the sensor signal based on time information included in the first time tag and the second time tag.

7. The method of claim 6, wherein the sensor signal collection unit collects all sensor signals wirelessly transmitted by a plurality of the wireless sensors and transmits the collected sensor signals to the computing device.

8. The method of claim 6, wherein the computing device compares the time information of the first time tag with the time information of the second time tag and performs synchronization between the video signal and the sensor signal each having time information within a predetermined range based on a result of the comparison.

9. The method of claim 6, wherein the computing device transmits a control signal to control a first unit time to the camera device or transmits a control signal to control the second unit time to the wireless sensor based on speed of the subject for photography.

10. The method of claim 6, wherein the computing device assigns unique identification information to an event on which synchronization between the video signal and the sensor signal has been normally completed and stores the event in a data storage medium.
